(19) United States
(12) Patent Application Publication
(10) Pub. No.: US 2019/0342301 A1
(43) Pub. Date: Nov. 7, 2019

(54) Local Authentication of Devices Arranged as a Trust Family

(71) Applicant: Seagate Technology LLC, Cupertino, CA (US)

(72) Inventor: Christopher Nicholas Allo, Longmont, CO (US)

(21) Appl. No.: 15/969,363

(22) Filed: May 2, 2018

(51) Int. Cl. H04L 29/06

(52) U.S. Cl. CPC H04L 63/104; H04L 63/0884; H04L 63/0876

(57) ABSTRACT

Apparatus and method for establishing trust among processing devices arranged into a trust family. In some embodiments, each processing device in a group of devices has an internal token value as a unique ID value associated with the corresponding device. The internal token values are distributed among the various devices so that each device stores the internal token value of another device as an external token value. A host controller circuit authenticates the trust family by querying the devices and receiving responses therefrom. Each response is generated by a device using the external token value stored by the device. In this way, the trust family is authenticated by matching each of the external token values to each of the devices in the group. The devices may be data storage devices such as solid state drives (SSDs) in a multi-device storage environment.

### SUMMARY

Various embodiments of the present disclosure are generally directed to device authentication systems, and more particularly to the authentication of a group of devices arranged as a trust family.

In some embodiments, each processing device in a group of devices has an internal token value as a unique ID value associated with the corresponding device. The internal token values are distributed among the various devices so that each device stores the internal token value of another device as an external token value. A host controller circuit authenticates the trust family by querying the devices and receiving responses therefrom. Each response is generated by a device using the external token value stored by the device.

These and other features which characterize various embodiments of the present disclosure can be understood in view of the following detailed discussion and the accompanying drawings.

### BRIEF DESCRIPTION OF THE DRAWINGS

FIG. 1 is a functional block representation of a data processing system which operates in accordance with various embodiments of the present disclosure.

FIG. 2 shows a configuration of a computer network that may employ data processing elements of FIG. 1 in some embodiments.

FIG. 3 is a sequence diagram illustrating an authentication transaction carried out in some embodiments.

FIG. 4 is a functional block diagram of a trust family configured as a local group of devices in accordance with some embodiments.

FIG. 5 shows a key store for each of the storage devices in the trust family of FIG. 4.

FIG. 6 is a functional representation of one of the storage devices configured as a solid state drive (SSD) having the keystore of FIG. 5.

FIG. 7A is a trust family map showing circular one-way associations among the various members of the trust family in some embodiments.

FIG. 7B shows a corresponding trust family table for the circular associations of FIG. 7A.

FIG. 8A is another trust family map showing random one-way associations among the various members of the trust family in some embodiments.

FIG. 8B shows a corresponding trust family table for the random associations of FIG. 8A.

FIG. 9 is a flow chart for a trust family formation routine.

FIG. 10 is a flow chart for a trust family authentication routine.

FIG. 11 shows the operation of the local trust family (TF) host during the routine of FIG. 9.

FIG. 12 is a sample format for an authentication table maintained by the TF host of FIG. 11.

FIG. 13 shows an authentication sequence corresponding to FIG. 3 to validate a stranger device located during the processing of FIG. 11.

FIG. 14 shows a multi-device storage system in accordance with further embodiments.

FIG. 15 shows a storage enclosure from FIG. 14 in some embodiments.

FIG. 16 shows another storage enclosure from FIG. 14 in further embodiments.

FIG. 17 is a functional representation of the storage enclosure of FIG. 16.

FIG. 18 depicts a storage system with multiple trust families in some embodiments.

FIG. 19. Shows a storage device configured and operated in accordance with some embodiments.

### DETAILED DESCRIPTION

Data security schemes are used to reduce or eliminate unauthorized access to data processing systems. Data security schemes can employ a variety of cryptographic security techniques to protect such systems from third party attacks.

Some systems use a centralized trust-based security protocol to allow a particular host to gain access to a peripheral device, such as a data storage device. The protocol may involve various steps carried out to respectively authenticate the host, to authenticate the storage device to a remote centralized server (such as a trusted security infrastructure or TSI server), and to authenticate the server to the host and the storage device. Authentication can be carried out in a variety of ways such as through the use of encrypted challenge values, public and private encryption keys, hashes, digital signatures, biometric inputs, etc. Once the various entities have been mutually verified to each other, a secure operation can be carried out between the host and the peripheral device such as an access to a secured data storage volume, a change in device configuration, etc.

Centralized trust-based security protocols can require significant system resources at both the local device level and the remote server level to track and authenticate the various entities and the requested transactions. This can be time and bandwidth intensive, particularly in smaller applications such as private cloud environments where a number of local devices are utilized to provide distributed storage and processing capabilities. Moreover, centralized security protocols are not feasible in geographically remote locations where intermittent or non-existent communications can be maintained with the centralized security server resources.

Various embodiments of the present disclosure are generally directed to an apparatus and method for system authentication in a data processing environment. As explained below, some embodiments provide a local host device and a plurality of local peripheral devices, such as but not limited to data storage devices. The host device and the storage devices may form a storage node in a larger computer network, such as a private cloud environment. The arrangement is referred to as a trust family, with each storage device characterized as a member of the family. It is contemplated that each family member can communicate with the trust family host, but not necessarily directly with each other.

An identifying token is formed to uniquely describe each family member to the host. In one example, tokens are formed by applying a selected hash function to certain unique identification (ID) information associated with each storage device, such as serial numbers or other types of information.

Each family member stores its own token (referred to as an “internal token”) as well as the token for a different one of the other family members (referred to as an “external token”). The distribution of the external tokens among the various family members can be made in a variety of ways, such as in a circular pattern, a random pattern, etc. It is contemplated that a one-way association pattern is used so that a pair of the family members do not store the external tokens for each other.

During an initialization sequence, the host randomly requests one of the family members to supply its external token. The host directs communications among the remaining family members in an effort to establish a match for the supplied token. When a match is made, the pairing between token and family member is noted and recorded by the host. This processing continues until all tokens have been retrieved and matched to all available family members.

In most cases, all tokens will be matched to all available family members, at which point the entire family will have been authenticated. At this point, normal data I/O operations may commence, or further levels of authentication can be applied. There may be situations, however, where not all of the tokens will find a match, or new “stranger” devices are detected that do not belong to the family.

In one example, it may be that a previous family member underwent a failure condition and was replaced with a new replacement device since the last authentication cycle. If so, the local authentication process will operate to both detect the missing device and detect the new replacement device. The host performs the necessary processing to verify the cause for the discrepancy, such as checking a replacement log or other record that explains the cause of the situation. The host then performs a more detailed authentication process to add the new replacement device to the family.

In another example, one or more extra devices are found to be present among the various family members. This may occur as a result of a system upgrade where new devices are added to the existing pool of family members to expand the total storage capacity of the local group. In this case, the local authentication process will successfully locate and match all of the existing family members, but the additional devices will be detected as “left over” or “extra” devices. As before, the host will proceed to verify the cause for the discrepancy, such as by consulting a service log that indicates the new devices were added to the system, a secure user interface used to add new devices to the system, etc. If the new devices are found to be authorized devices, the host proceeds to add the new devices to the family, thus expanding the number of family members in the system. A redistribution of the tokens may take place at this point among all of the family members. In some cases, devices may be added through a procedure of crafting a unique hash and linking together known family members.

It is contemplated that all of the family members will reside in a single geographical location such as in one or more storage enclosures, racks, the same data center, etc. This is not necessarily required, however, as the various family members can be geographically distributed as desired. Thus, reference to “local” authentication means authentication without the need for the host to consult a centralized server or other authority to complete the authentication. This allows the system to secure an entire storage array for unattended usage.

A multi-level authentication process can be implemented. Individual groups of devices can form trust families that are individually authenticated as described above. The individual trust families can, in turn, be family members of an extended trust family that are similarly authenticated at the trust family level.

The system provides fast and efficient authentication. If the system verifies correctly, there is high trust that the system is authenticated and secure without the need to obtain certificates or other authentication information from a remote authority.

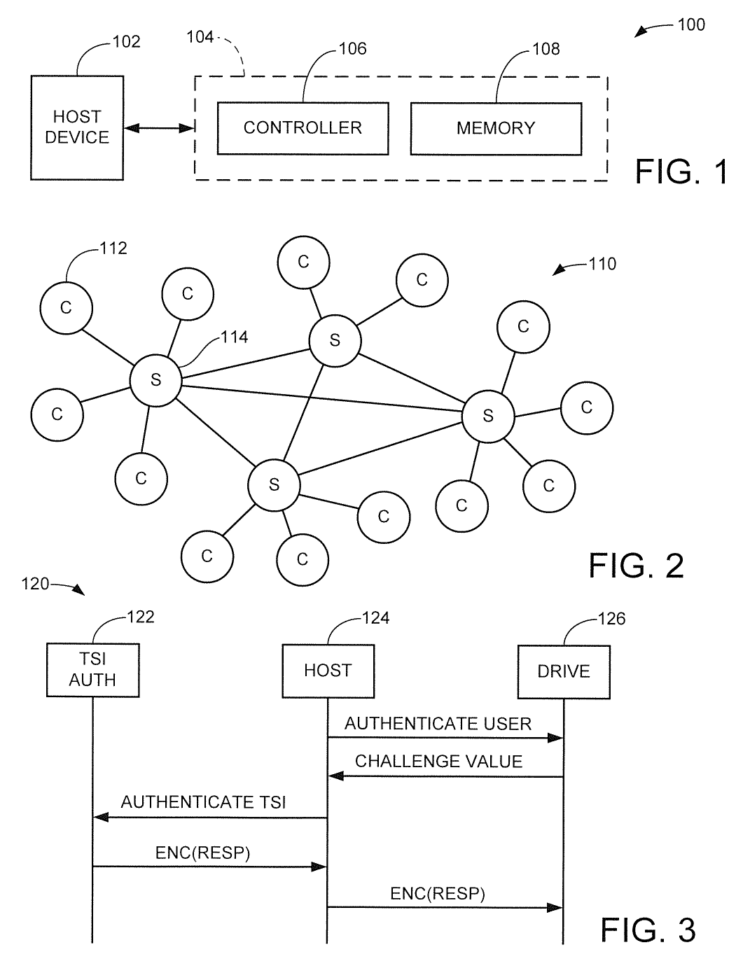

These and other features and advantages of various embodiments can be understood beginning with a review of FIG. 1 which shows a data processing system 100. The data processing system 100 includes a host device 102 operably coupled to a data storage device 104. This is merely exemplary as any number of different types of data processing environments can be used as desired, including environments that do not involve data storage systems.

The host device 102 and the data storage device 104 in FIG. 1 can each take a variety of forms. Without limitation, the host device 102 may take the form of a personal computer, workstation, server, laptop, portable handheld device, smart phone, tablet, gaming console, RAID controller, cloud controller, storage enclosure controller, etc. The data storage device 104 may be a hard disc drive (HDD), solid-state drive (SSD), hybrid solid state drive (HSSD), thumb drive, optical drive, an integrated memory module, a multi-device storage enclosure, etc. The data storage device 104 may be incorporated into the host device as an internal component or may be an external component accessible via a communication pathway with the host device 102 including a cabling connection, a wireless connection, a network connection, etc.

For purposes of the present discussion, it will be contemplated that the host device 102 is a computer and the data storage device 104 provides a main memory store for user data generated by the host device, such as flash memory in a solid state drive (SSD).

FIG. 2 shows a distributed computer network 110. The network 110 has a number of interconnected processing nodes including client (C) nodes 112 and server (S) nodes 114. The client nodes may represent local user systems with host computers 102 and one or more storage devices 104 as depicted in FIG. 1. The server nodes may interconnect groups of remotely connected clients. Other arrangements can be used. It will be understood that the authentication processing described herein can be carried out by both server and client nodes.

Generally, any node in the system can communicate directly or indirectly with any other node. The network 110 can be a private network, a public network, or a combination of both public and private networks. It is contemplated that the overall network 110 is a low trust environment potentially susceptible to attacks by third parties. Authentication security schemes are implemented to protect against such attacks, as will now be described.

FIG. 3 is a sequence diagram 120 illustrating a remote authentication sequence that may be carried out by aspects of the network 110 in accordance with some embodiments. A trusted security infrastructure (TSI) 122, also sometimes referred to as the TSI authority or the TSI authority circuit, is a logical entity comprised of hardware and/or software designated to handle certain functions within the protection scheme. The TSI authority 122 may be a separate server dedicated to this purpose, or may be managed and distributed as required among various nodes by authorized system administrators (administrative users). The TSI authority 122 may form a portion of a remote security (key) management system in which system authentication techniques, including the transfer of encryption keys, certificates or other authentication data are passed to provide access to the system. The TSI authority communicates to a device using a selected security protocol.

A host 124 and a drive 126 (e.g., an SSD) are arranged to communicate with the TSI authority 122. In this example, the host 124 initiates a sequence to gain authorized access a protected security aspect of the drive 124. In order to do so, sufficient trust must be established between the TSI authority 122, the host 124 and the drive 126. To authenticate each of these entities to the others, the host 124 may initiate the process such as by requesting an encrypted challenge string from the drive 126. The host may supply an initial value which is encrypted by the drive, or some other sequence may be employed. The challenge value may be forwarded to the TSI 122, which processes the challenge value in some way to provide an encrypted response, which may be processed by the host and the drive.

Once all entities are satisfied, the host proceeds with the requested transaction. Examples that may involve requested transactions may include normal data accesses including accesses to secured volumes, etc. Diagnostic functions may also be enacted such as installing new firmware, performing specific security actions such as secure erasure, drive unlock, enablement of serial ports, etc. Many such inter-entity sequences are known in the art, and substantially any suitable sequence can be used as desired.

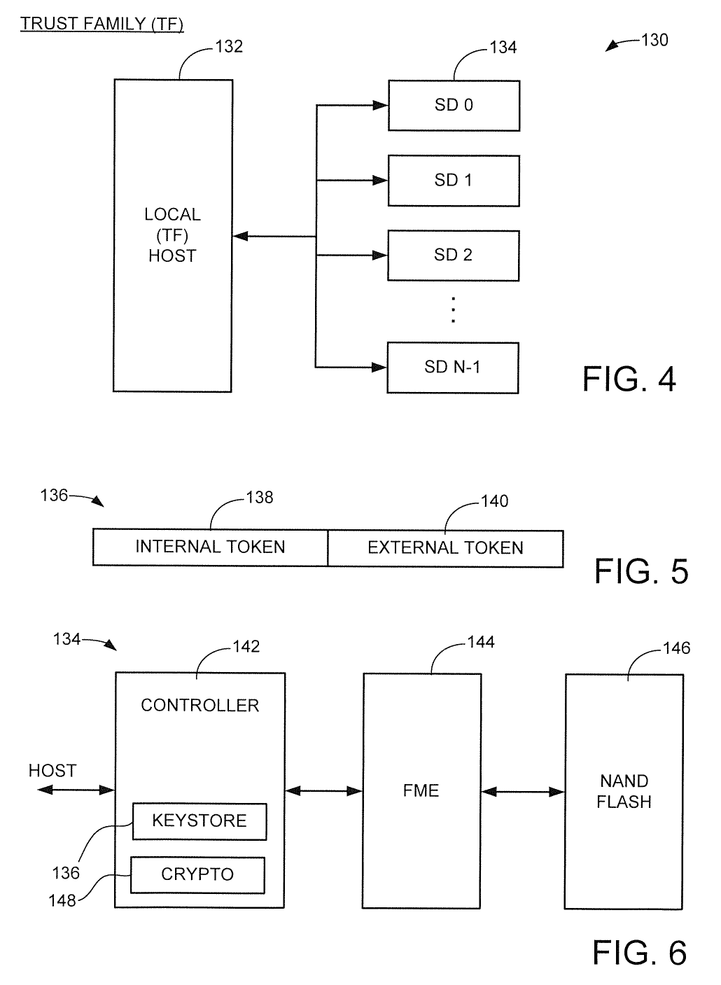

While operable, the centralized system 120 of FIG. 3 is not always suitable for certain types of authentication processing. One such example is provided in FIG. 4 which shows a local data storage group 130 constructed in accordance with some embodiments. The storage group 130 is also referred to herein as a trust family (TF). The trust family 130 can represent a local storage node of the network 110 of FIG. 2. in some embodiments, the trust family is physically disposed within an enclosure, rack or other device arrangement to provide local mass storage for an end user, such as in a private cloud environment.

The trust family 130 includes a local (TF) host 132 and a plural number N storage devices 134. These elements generally correspond to the host 102 and storage device 104 in FIG. 1. The host 132 include one or more programmable processors and associated programming to direct storage to the storage node formed by the trust family 130. The storage devices 134 are SSDs, but other forms of processing devices can be used. The storage devices are respectively referred to as family members.

The number N of family members can vary widely depending on the requirements of a given application, from values as low as 2-3 to values of several hundred or more. A suitable range for many applications may be around 5-20 devices, although families of up to about 200-300 or so may be useful for some environments. A large number of devices can be divided among multiple families to expedite authentication processing.

For local storage groups such as 130, it may not be suitable or feasible to undergo separate authentication of each of the storage devices in the manner set forth by FIG. 3. At the same time, failure to perform some sort of localized authentication at the device level could potentially provide an attacker with an opportunity to breach the system using a direct or side-channel attack.

Accordingly, the trust family is configured to carry out periodic localized authentication operations that do not require access to a remote authority such as the server 120 in FIG. 3. To this end, each of the family members 134 generates and stores certain cryptographic values used for authentication and, as required, data processing.

FIG. 5 shows a keystore 136 that may be provided as a memory location to store various values including an internal token 138 and an external token 140. The internal token 138 is associated with the family member and may be used as part of cryptographic processing operations. The external token 140 is the internal token for a different one of the family members in the trust family 130.

FIG. 6 is a functional block representation of one of the SSD family members 134 of FIG. 4. The SSD includes a top level controller 142, a flash memory electronics (FME) module 144 and a NAND flash memory array 146. Other configurations may be used.

The controller 142 may be in the form of one or more system on chip (SOC) integrated circuit devices that incorporate one or more programmable processors and associated firmware to execute various data transfer functions. The FME 144 is a controller circuit that operates to write data to and retrieve data from various flash dies of the flash memory 146.

The keystore 136 of FIG. 6 represents any suitable memory location or locations within the device 134. As shown in FIG. 6, the keystore may be an internal memory in the SOC device of the SSD 134. This reduces the ability of an attacker to gain access to the respective tokens. An alternative arrangement can be a secured encrypted area in the main memory, etc. A cryptographic engine 148 can be an embedded hardware circuit and/or processor routine that carries out various cryptographic functions, such as encryption, hashes, etc. to generate and use the contents of the keystore 136. Incorporation of the keystore into the SOC is not necessarily required; the respective internal and external tokens may be stored elsewhere in the system, including in local volatile or non-volatile memory, in the flash memory array 148, etc. The internal and external tokens can be stored in separate locations. Indeed, once the external tokens have been distributed, it is not necessarily required to retain the internal tokens by the respective storage devices.

The crypto block 138 of each family member 134 operates to generate the internal token for that device by applying a hash function to an input data stream associated with the device. In one embodiment, a secure hash algorithm (such as SHA-256) is applied to a device serial number and/or other unique ID values associated with the device.

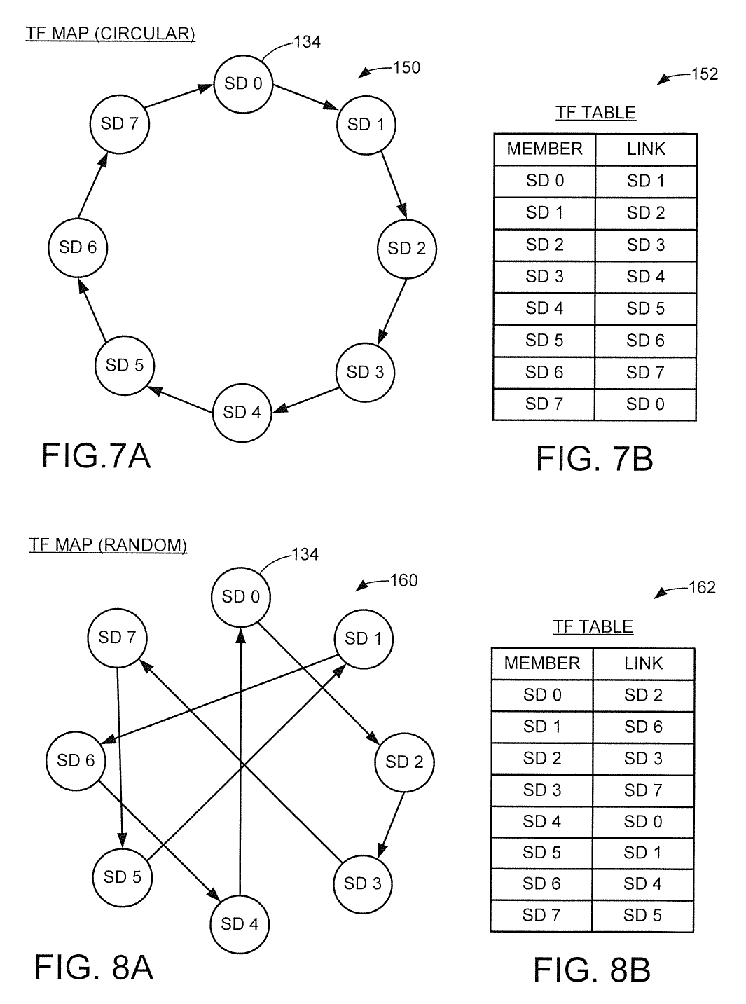

The TF host 132 operates to establish associations of the internal tokens so that the tokens are assigned and stored by the other family members in the group. FIG. 7A shows a circular association map. In FIG. 7A, a family 150 has eight (8) family members 134 identified as SD 0 to SD 7.

The internal token for each family member is passed as an external token to the immediately adjacent family member in the sequence; in this case the internal token for SD 0 becomes the external token for SD 1, the internal token for SD 1 becomes the external token for SD 2, and so on.

FIG. 7B provides a trust family table 152 to list these associations. The TF table 152 may be stored as a data structure in a local memory of the TF host 132.

FIG. 8A shows another arrangement for a family 160 in which the various tokens are distributed randomly among the various family members 134. In this case, the internal token for SD 0 is stored as an external token by SD 2, the internal token for SD 1 is the external token for SD 6, and so on.

Table 162 in FIG. 8B shows the arrangement of the map of FIG. 8A and, as before, may be stored by the TF host. The random associations can be established by the host 132 using a suitable entropy source and a random selection mechanism.

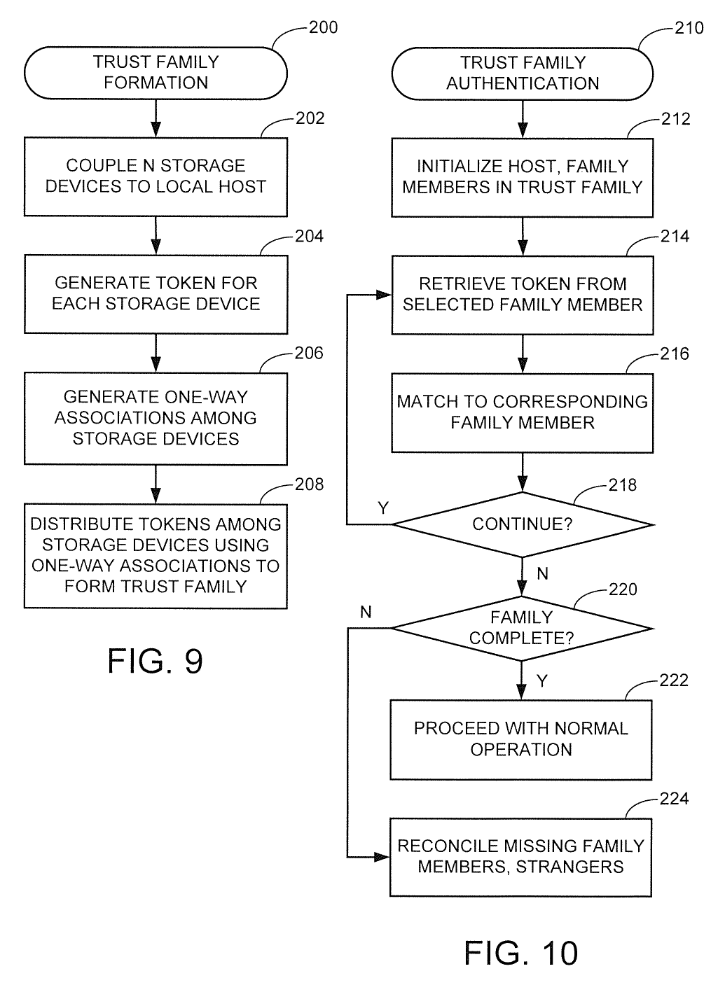

FIG. 9 provides a flow chart for a trust family formation routine 200 in accordance with some embodiments. The routine 200 is used to arrange a group of devices such as illustrated in FIG. 4 into a trust family with distributed tokens using a distribution pattern such as but not limited to those of FIGS. 7A and 8A. In some cases, the system may use a host device table, which shows a list of attached devices, as a guide to querying the various devices.

The process begins at step 202 by coupling N storage devices (such as 134) to one or more local host devices (such as 132). Each storage device is arranged to communicate with the host using a suitable interface protocol. The host communicates to remote devices via a larger network such as in FIG. 2.

Step 204 generates a token for each storage device in the group. This may be carried out as described above by having each storage device internally generate and store a separate token by hashing or otherwise processing unique device ID information. In other embodiments, the host 132 or other device(s) assign the token values to the various storage devices.

In step 206, the host generates associations among the various storage devices in the group. A one-way association is contemplated, albeit not necessarily required. A one-way association is a non-reciprocal arrangement such that no pair of devices store the external tokens of the other. This is in contrast to a two-way, reciprocal arrangement (e.g., SD 0 stores the external token for SD 1 and vice versa).

Once the association map has been established, the various tokens are distributed and stored as external tokens in the associated keystores 136 of the various devices 132 in the trust family 130 at step 208.

FIG. 10 is a flow chart for a trust family authentication routine 210 carried out upon a trust family formed by the routine of FIG. 9. It is contemplated that the routine 210 can be carried out at various suitable times such as during system initialization, after system resets, during scheduled security checks, etc. The routine can also be implemented on a random basis to verify existing security status.

The routine commences at step 212 where the host and the family members of the trust family are initialized. This may include bringing each of these devices from a deactivated state to an activated state. Each device may undergo a self-initialization (boot) process to bring the device to an operationally ready mode.

A local authentication of the trust family commences at step 214. The host selects a first external token for evaluation. The external token may be retrieved from one of the family member devices or may be recalled from an internal memory of the host.

At step 216, the host queries each of the family members in turn to identify a match for the external token. Various ways in which this matching process can be carried out will be discussed below. The token matching process continues for each external token in turn, as shown by decision step 218.

Decision step 220 determines whether the family has been determined to be complete by the repetitive processing of steps 214, 216 and 218. If so, all family members are present and accounted for on the basis that every external token found a corresponding device, and the routine passes to step 222 where normal operations are commenced by the family 130.

In some cases, the successful completion of the trust family authentication of FIG. 10 provides sufficient verification to enable normal host I/O accesses among the various devices. In other cases, the authentication routine is used as a fast-reject testing process to quickly assess the state of the system. In a fast-reject testing process, failures are quickly identified but successful completion of the test does not necessarily mean the system is fully authenticated, so further layers of security authentication can be applied.

Should one or more issues be identified during the processing of steps 214, 216 and 218, the routine passes to step 224 where corrective actions are taken by the host to resolve the issue. Examples include an extra unclaimed token that was not matched to any of the existing family members or one or more stranger devices that cannot produce a valid token or accept one of the existing tokens.

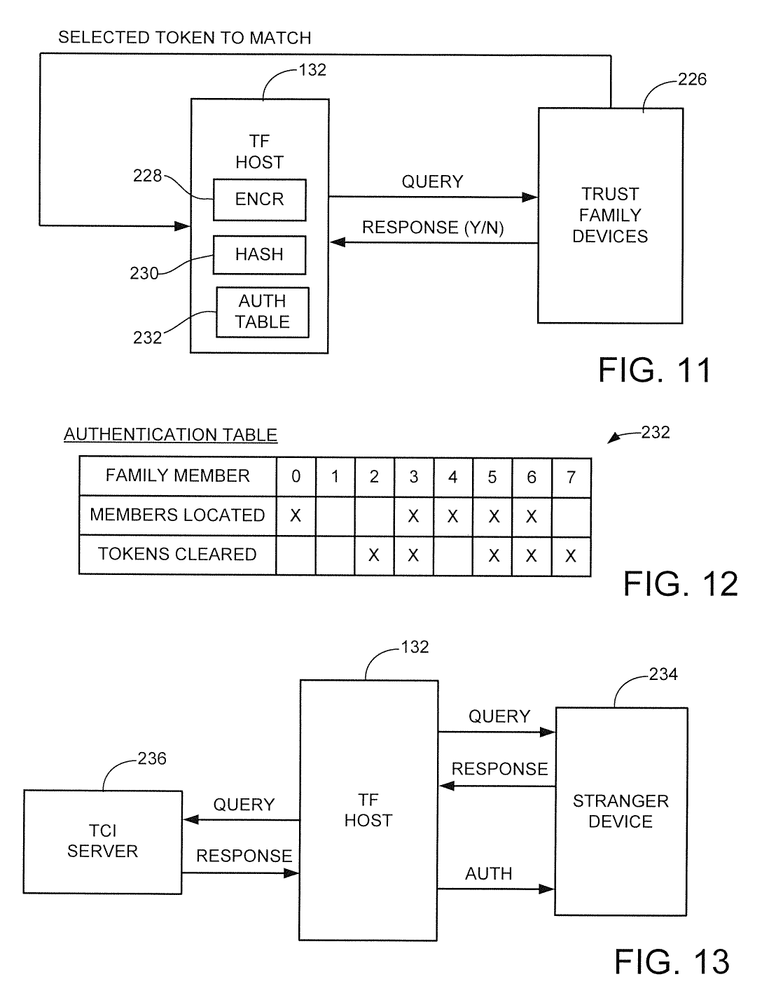

FIG. 11 is a functional block representation of the operation of the trust family 130 during the authentication routine of FIG. 10. The trust family devices are collectively identified at block 226. The host 1132 authenticates the trust family by providing a set of queries to the trust family devices. The trust family devices, in turn, generate a set of responses that are sent back to the host.

Generally, each query is formulated by the host using a separate one of the external tokens. The trust family devices respond to each query by formulating a response that is generated using the associated external token value stored in the keystore of the associated trust family device. The queries and responses can each take a variety of forms.

In one approach, each query simply comprises passing a selected external token to each family member in turn. Each family member that receives the selected external token compares the received token to the external token stored in its own keystore. If the tokens match, the family member responds with an affirmative message (e.g., “yes” or “the tokens match”); if the tokens do not match, the family member responds with a negative message (e.g., “no” or “the tokens do not match”). The communications may be carried out using secure communication protocols.

In more complex approaches, each selected external token is used in turn as an input to a cryptographic process to generate one or more cryptographic values that are passed between the host 132 to the various family members 226. In one example, the host generates a challenge value such as a multi-bit random sequence, and passes a query that includes the challenge value to each family member in turn.

Each family member hashes the challenge value with the external token in its keystore to provide a hashed output value that is returned to the host in a separate response. The host applies the same hash function to the challenge value, and compares the internally generated hashed output value to each of the hashed output values received in the responses from the family members. The family member that generated the same hashed output value as was produced by the host matches the associated token. This approach can add additional layers of security to the process.

It will be apparent that the external token values can be used in other cryptographic mechanisms to formulate the respective queries and responses. For example, the external tokens can be used as seed values, nonce values, encryption keys, etc. To this end, the host 132 is shown to include an encryption circuit 228 and a hash circuit 230 to carry out these and other forms of cryptographic functions.

Once a match is made using a first token, the host 132 can move on to formulating and sending a new set of queries using a second token, rather than continuing to send queries based on the first token to the remaining family members. Similarly, once a device has been matched to a token, there is no need to continue sending queries to, or receiving responses from, the matched device. Thus, in one approach, the queries provided by the host are not forwarded to already matched family members, so that over time an ever decreasing number of the devices receive queries until all of the matches are completed. This provides a matching rate that proceeds relatively slowly at first, but accelerates through the process until only a few tokens and devices are left, at which point the remaining matches are easily completed.

A more secure approach involves sending queries to every device, and obtaining responses from every device, based on every token and independently of the number of matches that have been achieved by the process. If N tokens are used for N devices, then this approach would require a total of N² query/response cycles (e.g., if there are eight devices and eight corresponding tokens (N=8), each device will receive and process eight tokens for a total of 8×8=64 query/response exchanges). Historical data can be accumulated and stored by the host with regard to which device matched each token, and this can be used to speed up future executions of the routine.

It will be appreciated that providing the same number of queries for every token and receiving the same number of responses to each query is computationally inefficient and involves numerous unnecessary calculations, comparisons, etc., particularly toward the end of the process when most of the tokens and devices will already have been successfully matched. However, this processing scheme masks the underlying algorithms and matching criteria, making it more difficult for an attacker to gain side-channel information regarding the authentication process.

The host 132 can use and maintain an internal authentication table 232 to track the progress of the authentication process as the host works through the various tokens and family members.

FIG. 12 shows an example format for the table 232. Other formats can be used so the format is generally provided to illustrate main elements that may be included. The table is stored as a data structure in a suitable memory location of the host. Checked (X) boxes indicate the various family members that have been located and the various tokens that have been cleared (e.g., found a match). Not all of the available boxes have been filled in FIG. 12, indicating ongoing processing is continuing. It is contemplated that upon a successful authentication operation, all boxes will have been filled, signifying the local trust family authentication was successful.

FIG. 13 shows further operation of the trust family 130 in a situation where the authentication processing of FIGS. 11-12 was not successfully completed. In FIG. 13, it is contemplated that at least one stranger device 234 has been detected within the family. As noted above, the presence of a stranger device can arise due to the failure and replacement of an existing family member or a system upgrade to add further capacity to the system without introduction to the family. Of course, a stranger device can also arise due to an attack by an unauthorized party.

A stranger device can be detected by having the host send a query to the device to request a token and getting a null response, by forwarding challenge values encoded by various tokens and getting null or improper responses, and so on. More generally, a stranger device will not properly respond to any of the available tokens that are currently assigned to the valid set of family members.

When a stranger device is detected, the host 132 can operate to undergo a more traditional authentication processing routine similar to that discussed above in FIG. 3, wherein various queries and responses are obtained between the host 132, the stranger device 234 and a remote TSI server 236 to authenticate each of these devices to the other. Once the stranger device has been determined as being an authenticated device, tokens can be generated and distributed as discussed above to add the stranger to the family.

A variety of token distribution strategies can be used when adding a new stranger device to an existing family. If the new stranger device replaces a failed family member that is no longer present in the group, the new stranger device can simply store the external token that was held by the failed family member, and the external token of the new stranger device can be distributed to the other family member that previously stored the external token for the failed family member.

If the new stranger device has been added to expand the size of the family, it may be more appropriate for the host device to form a new association pattern for all of the tokens among all of the family members. It is further possible for the host device to form new association patterns periodically among the family of devices as well. In one embodiment, after each successful authentication cycle, the host distributes new tokens among the various family members so that a different association is used for the next authentication cycle that is performed.

It is contemplated that the various family members will be located in the same general geographical location, so that the TF host and family member devices are sufficiently near one another to share a common geoposition such as in a multi-device storage enclosure, a rack, a data center, etc. It is possible, however, to geographically distribute the family members of a trust family, with communication between the host and the devices carried out using one or more networks to provide the local authentication described herein. Smaller family units can perform the local authentication processing, after which multiple family units may be treated as individual family members in a larger network of nodes (extended family) in a distributed system.

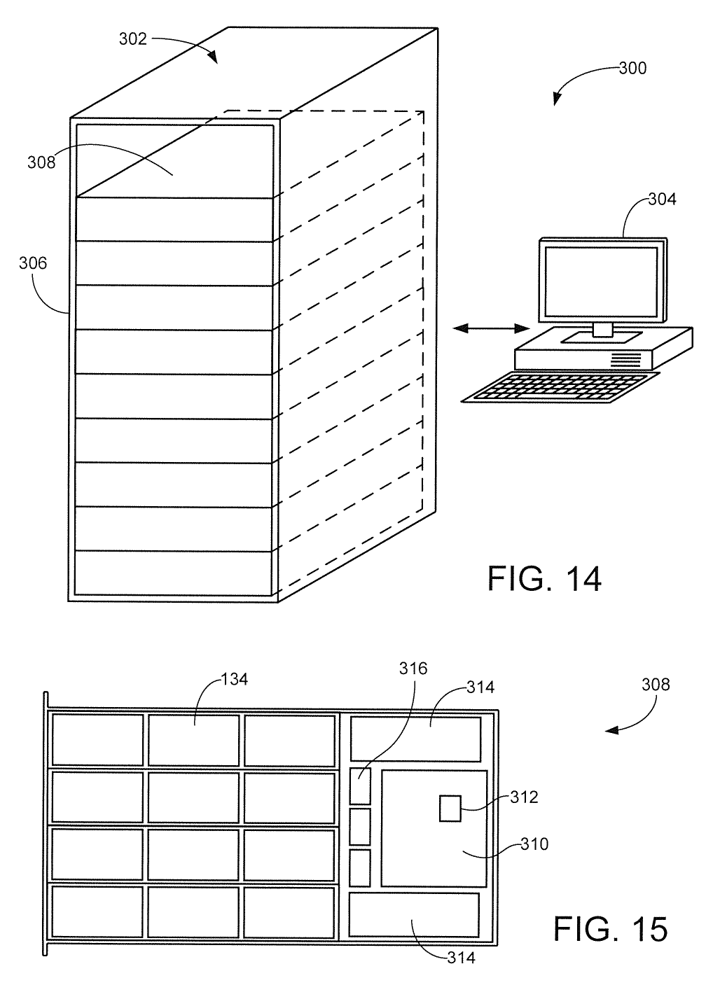

FIG. 14 provides a schematic depiction of a data storage system 300 in which various embodiments of the present disclosure may be advantageously practiced. The data storage system 300 is a mass-data storage system in which a large population of data storage devices such as 134 are incorporated into a larger data storage space to provide a storage node as part of a larger geographically distributed network. Examples include a cloud computing environment, a network attached storage (NAS) application, a RAID (redundant array of independent discs) storage server, etc.

The system 300 includes a storage assembly 302 and a computer 304 (e.g., server controller, etc.). The storage assembly 302 may include one or more server cabinets (racks) 306 with a plurality of modular storage enclosures 308. While not limiting, the storage rack 306 is a 42U server cabinet with 42 units (U) of storage, with each unit extending about 1.75 inches (in) of height. The width and length dimensions of the cabinet can vary but common values may be on the order of about 24 in.×36 in. Each storage enclosure 308 can have a height that is a multiple of the storage units, such as 2U (3.5 in.), 3U (5.25 in.), etc. to accommodate a desired number of adjacent storage devices 134. While shown as a separate module, the computer 304 can also be incorporated into the rack 306.

FIG. 15 is a top plan view of a selected storage enclosure 308 that incorporates 36 (3×4×3) data storage devices 134. Other numbers and arrangements of data storage devices can be incorporated into each enclosure, including different types of devices (e.g., HDDs, SDDs, etc.). The storage enclosure 308 includes a number of active elements to support the operation of the various storage devices, such as a controller circuit board 310 with one or more processors 312, power supplies 314 and cooling fans 316.

The modular nature of the various storage enclosures 308 permits removal and installation of each storage enclosure into the storage rack 306 including under conditions where the storage devices 134 in the remaining storage enclosures within the rack are maintained in an operational condition. In some cases, the storage enclosures 308 may be configured with access panels or other features along the outwardly facing surfaces to permit individual storage devices, or groups of devices, to be removed and replaced. Sliding trays, removable carriers and other mechanisms can be utilized to allow authorized agents to access the interior of the storage enclosures as required.

All of the storage devices 134 in the storage enclosure 308 can be incorporated into a trust family. In the example of FIG. 15, this would provide a trust family with 36 storage devices. The trust family host functions can be executed by the processors 312 on the storage enclosure control board 310. Each time the storage enclosure 308 is activated, and at other suitable times, the authentication processing of FIG. 10 can be carried out to quickly validate the integrity of the enclosure devices.

In further embodiments, sets of devices 134 within the storage enclosure 308 can be established as separate trust families, so that each storage enclosure incorporates two or more trust families within the same enclosure. In one example, N devices 134 in the storage enclosure 308 in FIG. 15 can form a first family, and the remaining 36-N devices 134 can form a second family. Performing authentication processing of these two trust families in parallel would tend to reduce authentication time.

In still other arrangements, trust families can be formed from storage devices 134 in different storage enclosures 308. This may be particularly suitable for devices that have been logically linked to provide certain separate functions (such as different logical volumes, different name spaces, etc.).

In another embodiment, a multi-level family trust structure can be generated using the storage system 302 of FIG. 14. In this scheme, each storage enclosure 308 forms a separate family unit, so that the devices in each storage enclosure are treated as family members under control of the associated host processor 312. Each storage enclosure 308, in turn, can be configured as a family member in a larger (extended) family unit, such as all of the storage enclosures shown in FIG. 14. Referring again to FIGS. 7A and 8A, each storage enclosure 308 can be substituted for the storage devices shown in these diagrams.

Each of the storage enclosures 308 can be provided with separate, unique storage enclosure tokens that are distributed to the other storage enclosures, and the extended family host (e.g., computer 304) can ensure that all of the storage enclosures 308 in the rack 306 are authorized family members before allowing data transfer operations with local or remote users. The multi-level scheme can require each storage enclosure 308 to verify that all data storage device family members are authorized before allowing the storage enclosure 308 to participate at the higher, storage enclosure level authentication.

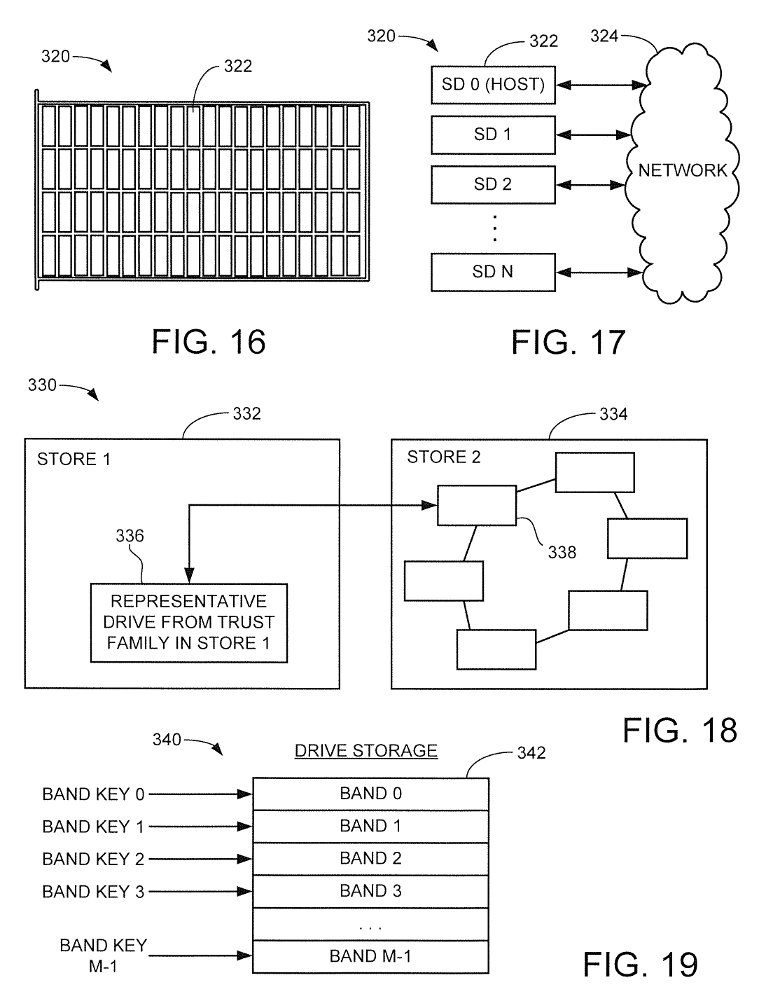

FIG. 16 shows another storage enclosure 320 that can be utilized in a system such as 300 in FIG. 14. The storage enclosure 320 is characterized as a JBOD (“just a box of drives”) and is arranged to store a large quantity of storage devices 322. The storage devices 322 can take any suitable form discussed above including HDDs, hybrid drives, SSDs, etc. A JBOD such as 320 generally just includes the drives along with the necessary support elements such as cabling, fans, power supplies, etc. as required. Separate intelligent controllers can be provisioned elsewhere in the system, or the drives can be individually intelligent enough to communicate and negotiate various tasks.

FIG. 17 shows the JBOD 320 as a plural number N of the storage devices 322 each arranged to communicate via a network 324. This allows each storage device to communicate with other storage devices as required.

It follows from FIGS. 16-17 that in some cases, it is not necessary to have the host take the form of a separate and distinct element in the trust family; rather, as shown in FIG. 17, a selected device (in this case, SD 0) can utilize the internal processor circuit (see e.g., FIGS. 1 and 6) of the device to carry out the host functionality during the trust family verification cycle.

FIG. 18 further shows a storage system 330 with two separate storage spaces 332, 334, respectively referred to as Store 1 and Store 2. These may take the form of JBODs or other arrangements of multiple storage devices. In this example, a selected storage device 336 in Store 1 can be designated as a representative drive from the trust family in Store 1. This enables the drive 336 to communicate with another group of storage devices 338 in Store 2. This allows a number of operations within a trust environment such as allowing drives in Store 2 to join the trust family in Store 1 (or vice versa), allowing the representative drive 334 to hold the keys and perform the trust family verification sequence for Store 2, and so on. Various tiered arrangements can be used for family representative devices to interface with other layers of trust family groups.

The discussion thus far has contemplated that the entire internal storage space of a given storage device is authenticated and verified during the trust family sequence. While this can be carried out in various embodiments, in additional embodiments the verification and trust family membership can be at a block or band level. FIG. 19 shows a representation of a non-volatile memory (NVM) storage space 340 of a selected storage device. The space 340 is divided up into a plural number M bands 342, from Band 0 to Band M-1. The respective bands may represent physical or logical portions of the total available capacity of the NVM 340. The bands may all have the same nominal size or may constitute different total storage capacities, as desired.

Generally, the bands 342 can be allocated to different users, or owners, as entities that have authorization to utilize the associated storage space for the storage of data. A different band key (e.g., Band Key 0 to Bank Key M-1) can be supplied to respectively encrypt and decrypt the data stored in each band 342. In some cases, multiple bands may be owned by the same owner.

It follows that a trust family may be formed among different bands, so that the access module that governs access to Band 0 may be a first family member, that for Band 1 may be a second band member, and so on. Thus, family members are associated with data storage devices, but multiple family members may reside in the same physical storage device. These and other alternatives will readily occur to the skilled artisan in view of the present disclosure.

It will now be appreciated that the various embodiments discussed herein can provide a number of benefits. Localized authentication as exemplified herein can provide fast and efficient validation of family members with a high level of trust. While various embodiments have contemplated an illustrative environment that uses a group of storage devices such as SSDs, it will be appreciated that the various examples are not so limited and that the various processing herein can be applied to any number of different groups and types of processing devices, such as computing devices, communication devices, sensing devices, etc. that utilize security measures to provide and govern security access.

It is to be understood that even though numerous characteristics and advantages of various embodiments of the present disclosure have been set forth in the foregoing description, this description is illustrative only, and changes may be made in detail, especially in matters of structure and arrangements of parts within the principles of the present disclosure to the full extent indicated by the broad general meaning of the terms wherein the appended claims are expressed.

What is claimed is:

1. An apparatus comprising:
a plurality of processing devices arranged as a trust family, each processing device storing an internal token value and an external token value, the internal token value comprising a unique ID value associated with the corresponding processing device, the external token value comprising the unique ID value for one other processing device in the trust family; and
a host controller circuit configured to authenticate the trust family by providing a set of queries to the processing devices and receiving a set of responses from the processing devices, the set of responses generated using the external token values stored by the respective processing devices.

2. The apparatus of claim 1, wherein the host controller circuit authenticates the trust family by generating a first query of the set of queries using a selected one of the external token values, forwarding the first query to each of the processing devices, and evaluating a corresponding response from each of the processing devices generated using the external token value stored by the associated processing device.

3. The apparatus of claim 2, wherein the first query comprises a copy of the selected external token value, each of the processing devices performs a comparison operation to compare the copy of the selected external token value received from the host controller circuit to the external token value stored by the associated processing device and provides a response to the host controller circuit comprising a result of the comparison operation.

4. The apparatus of claim 2, wherein the first query comprises a challenge value, each of the processing devices performs a cryptographic function to combine the challenge value with the external token value stored by the associated processing device to generate an output value and provides a response to the host controller circuit comprising the output value, and wherein the host controller circuit evaluates each of the output values received from the processing device.

5. The apparatus of claim 1, wherein the internal token value for each selected processing device comprises applying a selected hash function to a unique identification (ID) value associated with the selected processing device.

6. The apparatus of claim 1, wherein the host controller circuit forms a one-way association among the processing devices so that each processing device stores the internal token value from a single one of the other processing devices in the trust family.

7. The apparatus of claim 6, wherein the host controller circuit uses entropy from an entropy source to establish the one-way association among the processing devices.

8. The apparatus of claim 6, wherein the host controller circuit establishes the one-way association as a circular association based on logical addresses of the respective processing devices.

9. The apparatus of claim 1, wherein the processing devices comprise data storage devices each having a data storage device controller circuit and a non-volatile memory (NVM) to store user data supplied by the host device.

10. The apparatus of claim 1, wherein the trust family comprises a first trust family, the apparatus comprising a plurality of additional trust families nominally identical to the first trust family, and wherein the apparatus further comprises a top level controller circuit that authenticates each of the first trust family and the additional trust families first trust family and the additional trust families.

11. A method comprising:
forming a trust family comprising a plurality of processing devices and a host controller circuit by generating an internal token value for each processing device and storing each internal token value as an external token value in a different one of the processing devices, each internal token value comprising a unique ID value associated with the corresponding processing device; and
authenticating the trust family by using the host controller circuit to generate a query, to forward the query to each of the processing devices, and to evaluate a response supplied to the host controller circuit by each processing device in response to the query, each response generated by the associated processing device using the external token value stored by the associated processing device.

12. The method of claim 11, wherein the host controller circuit generates a separate query for each of the external token values in turn and supplies each of the separate queries to each of the processing devices.

13. The method of claim 11, wherein the query comprises a copy of a selected external token value, each of the processing devices performs a comparison operation to compare the copy of the selected external token value received from the host controller circuit to the external token value stored by the associated processing device and provides a response to the host controller circuit comprising a result of the comparison operation.

14. The method of claim 11, wherein the query comprises a challenge value, each of the processing devices performs a cryptographic function to combine the challenge value with the external token value stored by the associated processing device to generate an output value and provides a response to the host controller circuit comprising the output value, and wherein the host controller circuit evaluates each of the output values received from the processing device.

15. The method of claim 14, wherein the host controller circuit performs the cryptographic function to combine the challenge value with a copy of the selected external token value to generate a second output value, and compares the second output value with each output value supplied by each processing device.

16. The method of claim 11, wherein the authenticating step establishes trust among the trust family without communications between the host controller circuit or the processing devices with a remote server via a network.

17. The method of claim 11, further comprising detecting a stranger device that does not belong to the trust family during the authenticating step, performing a separate authentication of the stranger device using a remote server to add the stranger device to the trust family.

18. The method of claim 11, further comprising applying a selected hash function to a unique identification (ID) value associated with the each processing device to form the associated internal token value.

19. The method of claim 11, wherein each processing device stores only one internal token value from only one other processing device in the trust family.

20. The method of claim 11, wherein the processing devices comprise data storage devices each having a data storage device controller circuit and a non-volatile memory (NVM) to store user data supplied by the host device, and wherein each selected storage device further comprises a keystore that stores the internal token value and the external token value associated with the selected data storage device.
